(19) United States
(12) Patent Application Publication
(10) Pub. No.: US 2008/0289774 A1
(43) Pub. Date: Nov. 27, 2008

(54) Headrail covering structure for blinds

(75) Inventor: Liang Wen Ying, Lu Kang Chen (TW)

Correspondence Address: TROXELL LAW OFFICE PLLC, SUITE 1404, 5205 LEESBURG PIKE, FALLS CHURCH, VA, 22041, US

(73) Assignee: Ching Feng Home Fashions Co., Ltd.

(21) Appl. No.: 11/802,588

(22) Filed: May 23, 2007

(51) Int. Cl. E06B 9/323

(52) U.S. Cl. 160/178.1 R

(57) ABSTRACT

A headrail covering structure for blinds comprises a headrail defined by a receiving channel to which a cord-winding control device, a movable seat, and a fixed seat are respectively mounted so as to control a lift cord and actuate a blind body collected upwards or expanded downwards thereby, forming a cordless window blind structure. The cord-winding control device and the fixed seat have the top surfaces respectively equipped with a connecting element composed of a set of upper and lower conjoining surfaces. A covering sheet identical to the headrail in length is provided to attach to the upper conjoining surfaces of the connecting elements, while the lower conjoining surfaces of the connecting elements are respectively adhered onto the cord-winding control device and the fixed seat. Therefore, via the sheltering of the covering sheet, the receiving channel of the headrail can achieve dustproof effect and protect each assembling part accommodated therein.

### BACKGROUND OF THE INVENTION

The present invention relates to a headrail covering structure for blinds, comprising a headrail having a cord-winding control device, a movable seat, and a fixed seat mounted thereto wherein connecting elements each having a set of upper and lower conjoining surfaces are adhered onto the top surfaces of the cord-winding control device and the fixed seat respectively, and a covering sheet identical to the headrail in length is attached to the upper conjoining surfaces of the connecting elements; whereby, via the sheltering of the covering sheet, the headrail can achieve dustproof effect and protect each assembling part accommodated therein.

Conventional window blinds include headrails with hollow-out top sides exposed outwards. In the long run, dust and dirt can easily collect in the headrail and become hard to clean, which can cause the assembling parts accommodated inside the headrail to get jammed and unable to move in operation. Furthermore, a conventional cordless window blind which can avoid the risk of strangling children by the neck as disclosed in Taiwan Patent No. M296300 depends mainly on assembling parts received inside the headrail to actuate lift cords in operation. Thus, in case the headrail has too much dust or dirt accumulated therein, the assembling parts received therein will fail to actuate the movement of the lift cords smoothly, which can not only cause the inconvenience in application but also reduce their durability thereof.

### SUMMARY OF THE PRESENT INVENTION

It is, therefore, the primary purpose of the present invention to provide a headrail covering structure for blinds wherein connecting elements each having a set of upper and lower conjoining surfaces are utilized and combined with a covering sheet so as to shelter a receiving channel of a headrail and protect each assembling part mounted to the receiving channel therein, achieving dustproof effect; whereby, the window blind can be easily and smoothly operated without a lift cord mounted inside the headrail getting caught or jammed by dust or dirt as found in the above conventional blind structure, achieving the best application state thereby.

It is, therefore, the second purpose of the present invention to provide a headrail covering structure for blinds wherein the connecting element is equipped with a certain thickness and composed of a set of upper and lower conjoining surfaces, permitting speedy and easy assembly of the covering sheet so as to reduce the cost of production, and boost economical benefit and the competitiveness of the present invention thereby.

### BRIEF DESCRIPTION OF THE DRAWINGS

FIG. 1 is an exploded perspective view of the present invention.

FIG. 2 is an assembled perspective view of the present invention.

FIG. 3 is an assembled cross sectional view of the present invention.

FIG. 4 is a partially enlarged and assembled cross sectional view of the present invention.

### DETAILED DESCRIPTION OF THE PREFERRED EMBODIMENTS

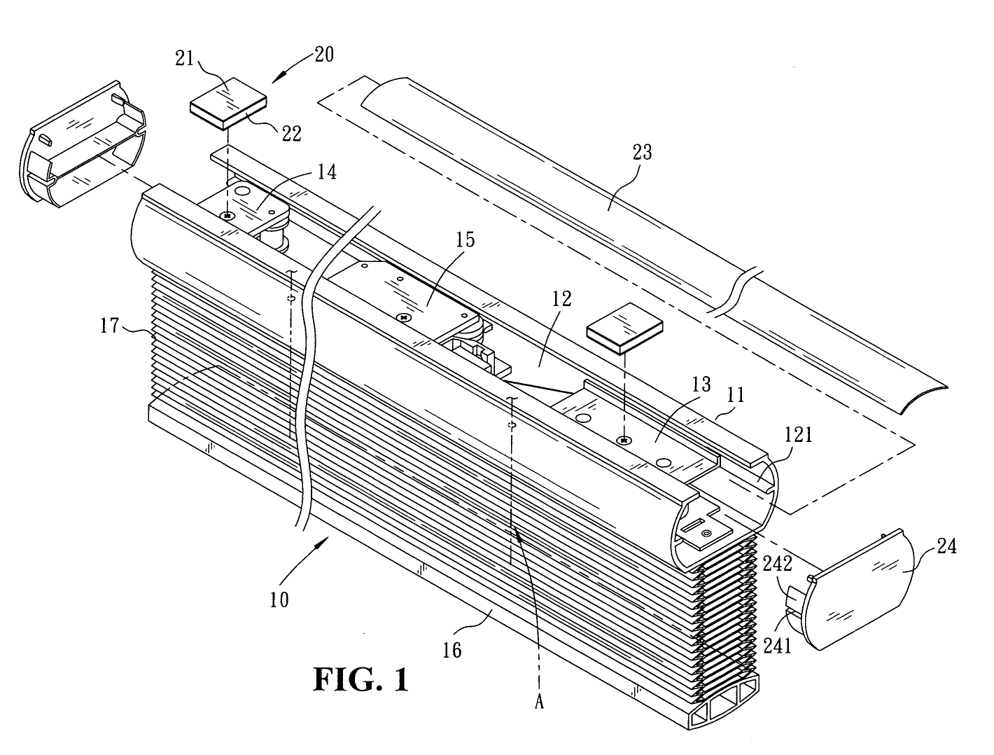

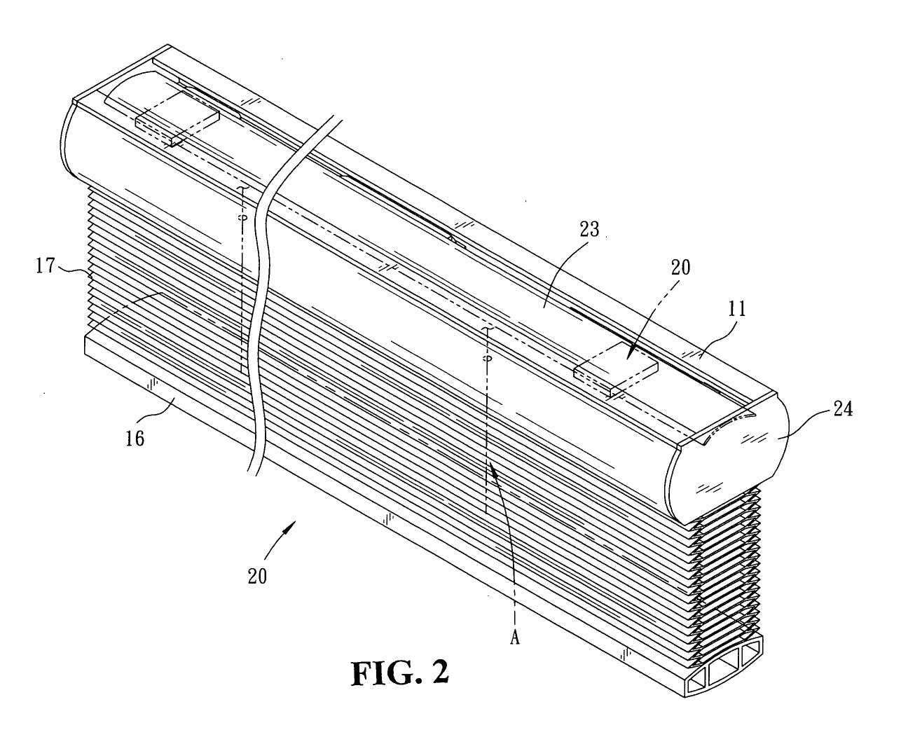

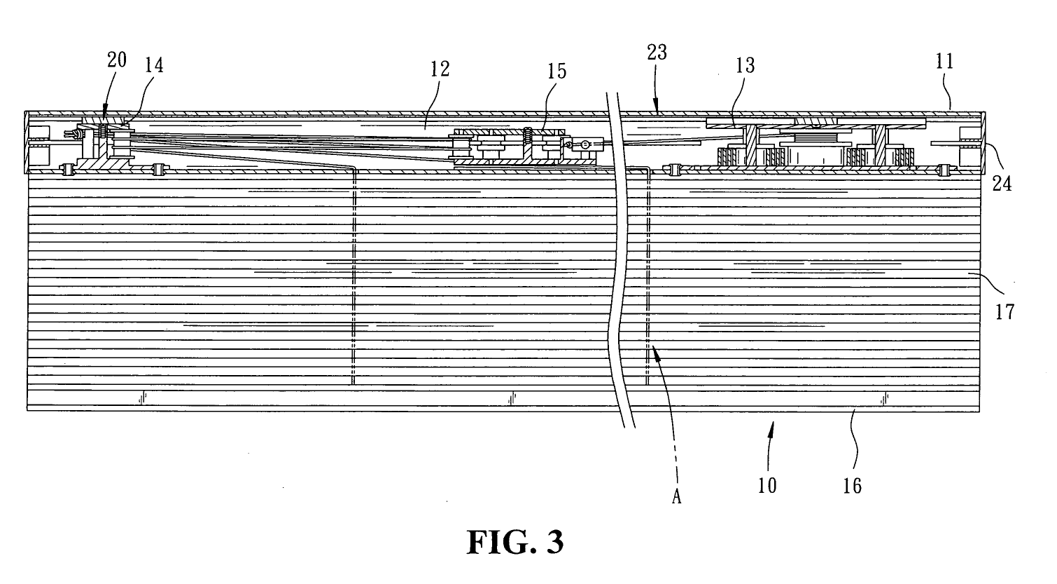

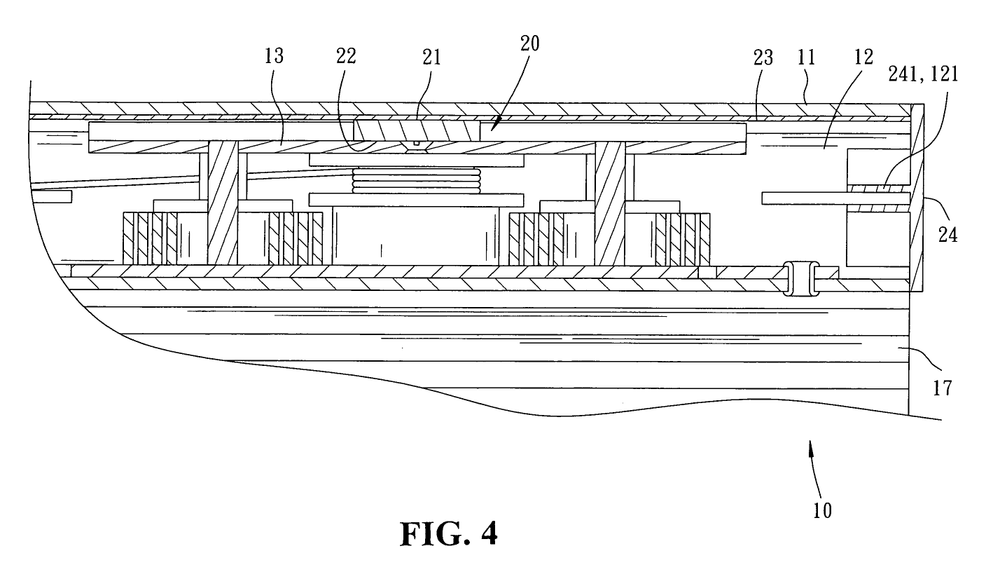

Please refer to FIG. 1 showing an exploded perspective view of the present invention (accompanied by FIGS. 2 to 4 inclusive). The present invention relates to a headrail covering structure for blinds, comprising a headrail 11 having a top side defined by a receiving channel 12, and a cord-winding control device 13 and a fixed seat 14 are respectively mounted and fixed to both end sides of the receiving channel 12 therein. A movable seat 15 is accommodated between the cord-winding control device 13 and the fixed seat 14 to slide along the inner sidewalls of the receiving channel 12 thereon. A lift cord A mounted to a bottom rail 16 and a blind body 17 is wound through the movable seat 15 and the fixed seat 14 to be coiled or released by the cord-winding control device 13 so as to actuate the movable seat 15 and, thus, collect upwards or expand downwards the blind body 17 therewith, providing a cordless window blind 10 thereby. The cord-winding control device 13 and the fixed seat 14 have the top surfaces respectively equipped with a connecting element 20 made up of a set of upper and lower conjoining surfaces 21, 22. A covering sheet 23 having a length identical to that of the headrail 11 is provided to reciprocally attach to the upper conjoining surfaces 21 of the connecting elements 20 thereof. And the lower conjoining surfaces 22 of the connecting elements 20 are respectively adhered onto the cord-winding control device 13 and the fixed seat 14 thereof. The connecting element 20 can be made of double-sided adhesive tapes and equipped with an appropriate thickness. The headrail 11 can also a sealing cap 24 respectively mounted to both ends thereon. Via the sheltering of the sealing caps 24 and the covering sheet 23, the receiving channel 12 can accurately achieve dustproof effect so as to protect each assembling part accommodated inside the headrail 11. Therefore, the window blind 10 can be easily and smoothly operated without the lift cord A getting jammed or caught due to dust accumulated inside the headrail as found in the above conventional blind structure, achieving the best application state thereby.

The sealing cap 24 has both sides defined by insert grooves 241 to precisely fit to guide tracks 121 extending at both sidewalls of the receiving channel 121 and locate in place thereby. Both sides of the insert groove 241 are respectively equipped with an arcuate coupling section 242 identically matched to the form of the headrail 11 so as to precisely abut against the inner surfaces extending at both sides of the guide tracks 121 thereof.

What is claimed is:

1. A headrail covering structure for blinds, comprising a headrail defined by a receiving channel to which a cord-winding control device, a movable seat, and a fixed seat are respectively mounted therein so as to control a lift cord and actuate a blind body collected upwards or expanded downwards thereby, forming a cordless window blind structure; the present invention being characterized by that,
the cord-winding control device and the fixed seat have the top surfaces respectively equipped with a connecting element made up of a set of upper and lower conjoining surfaces, and a covering sheet having a length identical to that of the headrail is provided to attach to the upper conjoining surfaces of the connecting elements thereof, while the lower conjoining surfaces of the connecting elements are respectively adhered onto the cord-winding control device and the fixed seat thereof; therefore, via the sheltering of the covering sheet, the receiving channel of the headrail can achieve dustproof effect so as to protect each assembling part accommodated therein.

2. The headrail covering structure for blinds as claimed in claim 1 wherein the connecting element can be made of double-sided adhesive tapes and equipped with an appropriate thickness.

3. The headrail covering structure for blinds as claimed in claim 1 wherein the headrail can also have a sealing cap respectively mounted to both ends thereon.

4. The headrail covering structure for blinds as claimed in claim 1 wherein the sealing cap has both sides defined by insert grooves to precisely fit to guide tracks that, extending at both sidewalls of the receiving channel, are provided for the sliding movement of the movable seat thereon; both sides of the insert grooves are respectively equipped with an arcuate coupling section identically matched to the form of the headrail so as to precisely abut against the inner surfaces extending at both sides of the guide tracks thereof.
